(19) United States
(12) Patent Application Publication
(10) Pub. No.: US 2009/0208274 A1
(43) Pub. Date: Aug. 20, 2009

(54) Swivel coupling device

(76) Inventor: Feng Chia Liang, Taichung (TW)

Correspondence Address: CHARLES E. BAXLEY, ESQUIRE, 90 JOHN STREET, SUITE 309, NEW YORK, NY, 10038, US

(21) Appl. No.: 12/319,349

(22) Filed: Jan. 5, 2009

(30) Foreign Application Priority Data
Feb. 19, 2008 (TW) 097202918

(51) Int. Cl. F16G 15/08

(52) U.S. Cl. 403/164

(57) ABSTRACT

A swivel coupling device includes a base member having a stem extended from a carrier, and a channel formed in an outer peripheral portion of the stem, and a swivel member includes a passage formed in a support member, and an inner peripheral groove formed in the support member and communicating with the passage of the support member for forming an endless pathway between the support member of the swivel member and the stem of the base member when the stem is engaged into the passage of the support member and for receiving bearing members which prevent the support member of the swivel member and the stem of the base member from being disengaged from each other.

### BACKGROUND OF THE INVENTION

1. Field of the Invention

The present invention relates to a swivel coupling device, and more particularly to a swivel coupling device including an improved structure for solidly and stably coupling two rotary or swivel members together and for allowing the two rotary or swivel members to be smoothly rotated relative to each other and for preventing the two rotary or swivel members from being disengaged from each other.

2. Description of the Prior Art

Typical swivel coupling devices, snap hooks and buckles or fasteners comprise two rotary or swivel members, such as ring members, hook members, eye members, buckle members, loop members, or the like pivotally or rotatably coupled together for hooking or attaching to a load.

For example, U.S. Pat. No. 2,826,798 to Kahl et al. discloses one of the typical snap fasteners comprising an eye portion or tailpiece pivotally or rotatably coupled to a cylindrical body with a sleeve and an annular washer, and the sleeve includes a back end angulated to cooperate with a similarly angulated back end of the cylindrical body for solidly and stably coupling the cylindrical body and the eye portion or tailpiece together.

However, the sleeve and the cylindrical body and the eye portion or tailpiece are engaged with each other with a planar-contact such that a great friction may be formed between the sleeve and the cylindrical body and the eye portion or tailpiece, and such that the sleeve and the cylindrical body and the eye portion or tailpiece may be easily worn out after use.

U.S. Pat. No. 4,577,374 to Lii discloses another typical snap hook and buckle or fastener comprising a buckle body and a base pivotally or rotatably coupled together with an engaging ring which includes a cut and a recess formed therein.

However, the engaging ring and the buckle body and the base are also engaged with each other with a planar-contact such that a great friction may be formed between the engaging ring and the buckle body and the base and such that the engaging ring and the buckle body and the base may also be easily worn out after use.

U.S. Pat. No. 4,641,986 to Tsui et al. discloses a further typical multi-position eyebolt comprising a bonnet and a bushing pivotally or rotatably coupled together with a washer and a threaded stud.

However, the washer and the bonnet and the bushing are also engaged with each other with a planar-contact such that a great friction may be formed between the washer and the bonnet and the bushing and such that the washer and the bonnet and the bushing may also be easily worn out after use.

U.S. Pat. No. 4,665,592 to Kasai discloses a still further typical swivel snap hook comprising an eye member including an arm portion and a spherical enlarged end coupled to a hook member for pivotally or rotatably coupling the eye member and the hook member together.

However, the spherical enlarged end of the arm portion of the eye member is engaged with or secured to the hook member with a spherical and planar or surface-contact such that a great friction may also be formed or generated between the spherical enlarged end of the arm portion of the eye member and the hook member and such that the spherical enlarged end of the arm portion of the eye member and the hook member may also be easily scrubbed and worn out after use.

U.S. Pat. No. 5,248,176 to Fredriksson discloses a still further typical swivel coupling device comprising a pivotal coupling member pivotally or rotatably coupled to an anchor unit with a sleeve or cylindrical or tubular rotary member which is used for pivotally or rotatably the anchor unit and the pivotal coupling member together.

However, the sleeve or cylindrical or tubular rotary member and the anchor unit are also engaged or contacted with each other with a cylindrical or tubular or planar-contact such that a great friction may also be formed between the sleeve or cylindrical or tubular rotary member and the anchor unit and such that the sleeve or cylindrical or tubular rotary member and the anchor unit may also be easily worn out after use.

The present invention has arisen to mitigate and/or obviate the afore-described disadvantages of the conventional swivel coupling devices.

### SUMMARY OF THE INVENTION

The primary objective of the present invention is to provide a swivel coupling device including an improved structure for solidly and stably coupling two rotary or swivel members together and for allowing the two rotary or swivel members to be smoothly rotated relative to each other and for preventing the two rotary or swivel members from being disengaged from each other.

In accordance with one aspect of the invention, there is provided a swivel coupling device comprising a base member including a carrier having a hook opening formed in the carrier, and including a stem extended from the carrier, and including an outer peripheral channel formed in an outer peripheral portion of the stem, a swivel member including a support member, and a shank attached to the support member, and a compartment formed in the shank, and including a passage formed in the support member and communicating with the compartment of the shank, and including an inner peripheral groove formed in the support member and communicating with the passage of the support member, and including a screw hole formed in an outer peripheral portion of the support member and communicating with the peripheral groove of the support member, and the peripheral groove of the support member being arranged to be aligned with the outer peripheral channel of the stem of the base member for forming an endless pathway between the support member of the swivel member and the stem of the base member when the stem is engaged into the passage of the support member, a number of bearing members engaged into the screw hole of the support member and then engaged into the endless pathway that is formed between the support member of the swivel member and the stem of the base member to facilitate a rotating movement between the support member of the swivel member and the stem of the base member, and a fastener threaded or engaged with the screw hole of the support member for stably locking and retaining the bearing members in the endless pathway and between the support member of the swivel member and the stem of the base member and for preventing the bearing members from being disengaged from the support member of the swivel member and the stem of the base member, and for preventing the support member of the swivel member and the stem of the base member from being disengaged from each other.

The peripheral groove of the support member includes a semi-circular cross section, and the outer peripheral channel of the stem of the base member also includes a semi-circular cross section, such that the endless pathway which is formed between the support member of the swivel member and the stem of the base member includes a circular cross section.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a swivel coupling device in accordance with the present invention;

FIG. 2 is a partial exploded view of the swivel coupling device;

FIG. 3 is a partial cross sectional view of the swivel coupling device;

FIG. 4 is a perspective view similar to FIG. 1, illustrating the other arrangement of the swivel coupling device; and

FIG. 5 is a partial exploded view of the swivel coupling device as shown in FIG. 4.

### DETAILED DESCRIPTION OF THE PREFERRED EMBODIMENT

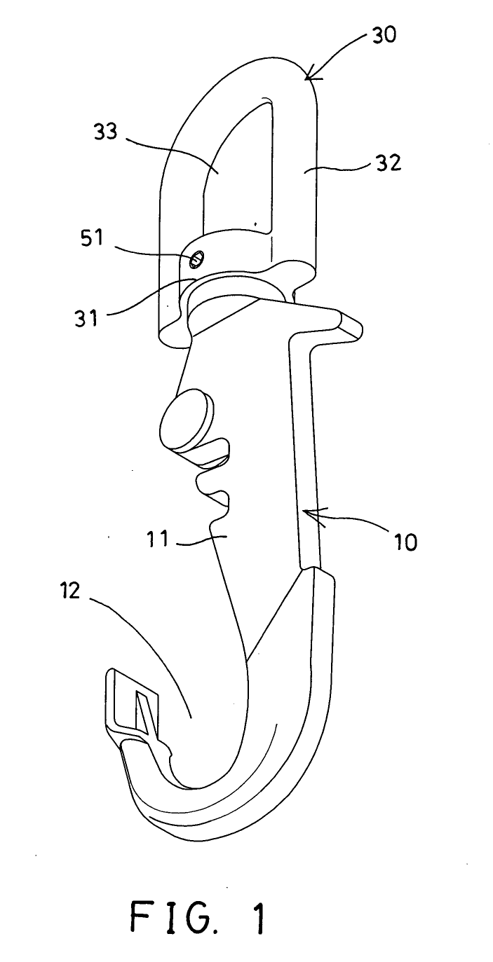

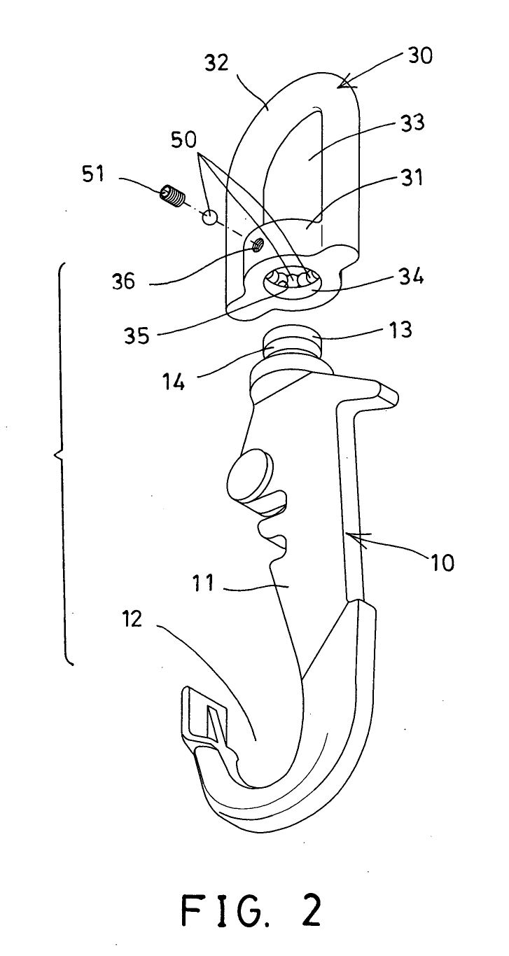

Referring to the drawings, and initially to FIGS. 1-3, a swivel coupling device in accordance with the present invention comprises a base member 10, and a rotary or swivel member 30 to be pivotally or rotatably coupled to the base member 10, in which the base member 10 may be selected form a buckle, a fastener, a ring, an eyebolt, an eyelet, a snap hook, or a hook member 10 as shown in FIGS. 1 and 2, and includes a body or carrier 11 having a hook space or opening 12 formed therein, and including a stud or stem 13 extended upwardly from the carrier 11, and including an outer peripheral channel 14 formed in the outer peripheral portion of the stem 13.

The rotary or swivel member 30 may be selected form a buckle, a fastener, an eyebolt, a snap hook, a hook member, an eyelet, or a ring 30 as shown in FIGS. 1 and 2, and includes a body or support member 31 and a hook or eyelet or ring or U-shaped shank 32 attached or secured to the support member 31, and an opening or compartment 33 formed in the shank 32 or formed between the support member 31 and the shank 32 for receiving straps or ropes or cables (not shown), and includes an orifice or passage 34 formed in or through the support member 31 and communicating with the compartment 33 of the shank 32 for pivotally or rotatably receiving the stem 13 of the base member 10.

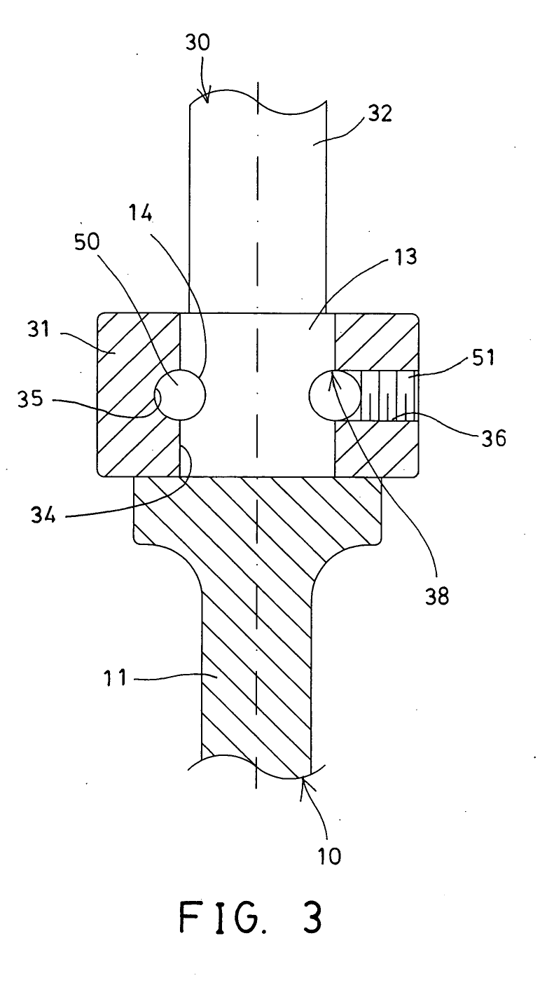

The rotary or swivel member 30 further includes an annular or peripheral groove 35 formed in the inner peripheral portion of the support member 31 and communicating with the passage 34 of the support member 31, and includes an aperture or screw hole 36 formed in the outer peripheral portion of the support member 31 and communicating with the peripheral groove 35 of the support member 31. As shown in FIG. 3, the peripheral groove 35 of the support member 31 is arranged to be aligned with the outer peripheral channel 14 of the stem 13 of the base member 10 when the stem 13 is engaged into or through the passage 34 of the support member 31.

As also shown in FIG. 3, the peripheral groove 35 of the support member 31 includes a semi-circular cross section, and the outer peripheral channel 14 of the stem 13 of the base member 10 also includes a semi-circular cross section, such that an annular or peripheral or endless pathway 38 of a circular cross section may be formed between the support member 31 of the swivel member 30 and the stem 13 of the base member 10 for slidably or rotatably receiving balls or rollers or bearing members 50 therein and for solidly and stably coupling the support member 31 of the swivel member 30 and the stem 13 of the base member 10 together and for allowing the support member 31 of the swivel member 30 and the stem 13 of the base member 10 to be smoothly rotated relative to each other and for preventing the support member 31 of the swivel member 30 and the stem 13 of the base member 10 from being disengaged from each other.

The bearing members 50 may be engaged into or through the screw hole 36 of the support member 31, and then may be engaged into the endless pathway 38 that is formed between the support member 31 of the swivel member 30 and the stem 13 of the base member 10 when the stem 13 is engaged into or through the passage 34 of the support member 31. A bolt or screw or fastener 51 may then be threaded or engaged with the screw hole 36 of the support member 31 for solidly and stably locking and retaining the bearing members 50 in the endless pathway 38 that is formed between the support member 31 of the swivel member 30 and the stem 13 of the base member 10, and for preventing the bearing members 50 from being disengaged from the support member 31 of the swivel member 30 and the stem 13 of the base member 10, and for allowing the bearing members 50 to facilitate the rotating or sliding movement between the support member 31 of the swivel member 30 and the stem 13 of the base member 10.

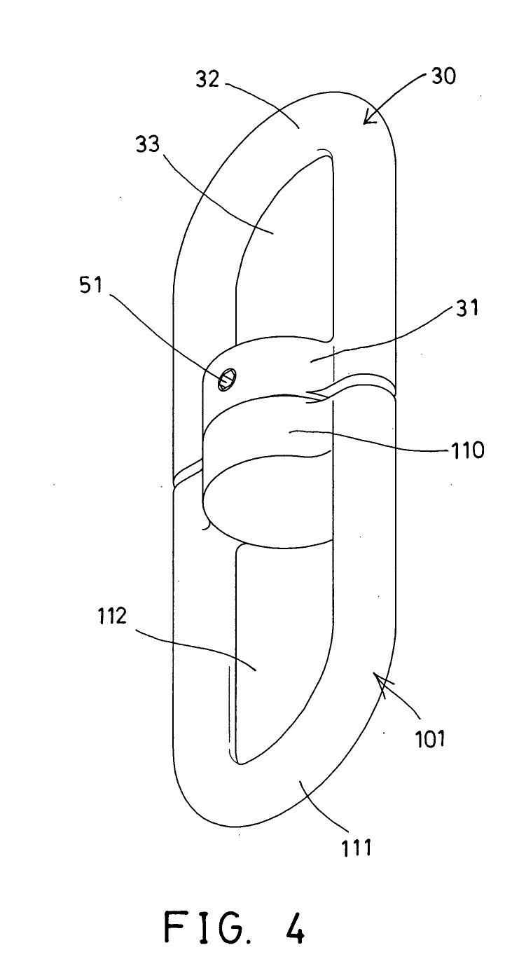

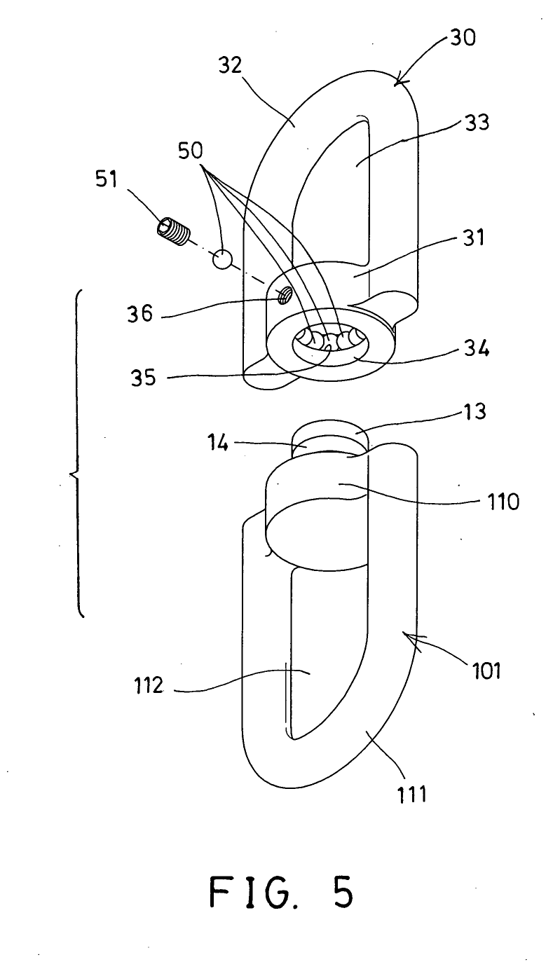

Alternatively, as shown in FIGS. 4 and 5, the base member 101 may also be selected form a buckle, a fastener, an eyebolt, a snap hook, a hook member, an eyelet, or a ring 101 including a body or support member 110 and a hook or eyelet or ring or U-shaped shank 111 attached or secured to the support member 110, and an opening or compartment 112 formed in the shank 111 or formed between the support member 110 and the shank 111 for receiving straps or ropes or cables (not shown), and including the stem 13 extended upwardly from the support member 110, and including the outer peripheral channel 14 formed in the outer peripheral portion of the stem 13 for slidably or rotatably receiving the bearing members 50.

It is to be noted that the bearing members 50 and the support member 31 of the swivel member 30 and the stem 13 of the base member 10 are engaged or contacted with each other with or in a point-contact such that the contact area between the bearing members 50 and the support member 31 of the swivel member 30 and the stem 13 of the base member 10 may be greatly reduced and such that the rotating or sliding movement between the support member 31 of the swivel member 30 and the stem 13 of the base member 10 may be facilitated.

Accordingly, the swivel coupling device in accordance with the present invention includes an improved structure for solidly and stably coupling two rotary or swivel members together and for allowing the two rotary or swivel members to be smoothly rotated relative to each other and for preventing the two rotary or swivel members from being disengaged from each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A swivel coupling device comprising:
a base member including a carrier having a hook opening formed in said carrier, and including a stem extended from said carrier, and including an outer peripheral channel formed in an outer peripheral portion of said stem,
a swivel member including a support member, and a shank attached to said support member, and a compartment formed in said shank, and including a passage formed in said support member and communicating with said compartment of said shank, and including an inner peripheral groove formed in said support member and communicating with said passage of said support member, and including a screw hole formed in an outer peripheral portion of said support member and communicating with said peripheral groove of said support member, and said peripheral groove of said support member being arranged to be aligned with said outer peripheral channel of said stem of said base member for forming an endless pathway between said support member of said swivel member and said stem of said base member when said stem is engaged into said passage of said support member,
a plurality of bearing members engaged into said screw hole of said support member and then engaged into said endless pathway that is formed between said support member of said swivel member and said stem of said base member to facilitate a rotating movement between said support member of said swivel member and said stem of said base member, and
a fastener engaged with said screw hole of said support member for locking and retaining said bearing members in said endless pathway and between said support member of said swivel member and said stem of said base member and for preventing said bearing members from being disengaged from said support member of said swivel member and said stem of said base member and for preventing said support member of said swivel member and said stem of said base member from being disengaged from each other.

2. The swivel coupling device as claimed in claim 1, wherein said peripheral groove of said support member includes a semi-circular cross section, and said outer peripheral channel of said stem of said base member also includes a semi-circular cross section, such that said endless pathway which is formed between said support member of said swivel member and said stem of said base member includes a circular cross section.
